(19) United States
(12) Patent Application Publication
(10) Pub. No.: US 2026/0012665 A1
(43) Pub. Date: Jan. 8, 2026

(54) METHODS AND DEVICES FOR IMPROVING STORAGE AND TRANSMISSION OF UNCOMPRESSED DATA WHILE USING A STANDARD FORMAT

(71) Applicant: CANON KABUSHIKI KAISHA, Tokyo (JP)

(72) Inventors: Franck DENOUAL, SAINT DOMINEUC (FR); Frédéric MAZE, LANGAN (FR); Jean LE FEUVRE, GOMETZ-LE-CHÂTEL (FR)

(21) Appl. No.: 19/249,865

(22) Filed: Jun. 25, 2025

(30) Foreign Application Priority Data
Jul. 8, 2024 (GB) 2409909.5

(51) Int. Cl. H04N 21/2343

(52) U.S. Cl. CPC H04N 21/234345

(57) ABSTRACT

A method for encapsulating media data as samples into a media file comprising at least one media data part and at least one metadata part, by a processing device. The method comprises generating, based on the media data, at least one sample and generating metadata in the at least one metadata part, the generated metadata describing each byte-range of a sequence of byte-ranges of media data of the at least one sample. Metadata describing at least one byte-range of the sequence refer to media data of at least a part of another byte-range of the at least one sample or of a run of samples comprising the at least one sample.

### CROSS REFERENCE TO RELATED APPLICATION

This application claims the benefit under 35 U.S.C. § 119(a)-(d) of United Kingdom Patent Application No. 2409909.5, filed on Jul. 8, 2024 and entitled “Methods and devices for improving storage and transmission of uncompressed data while using a standard format”. The above cited patent application is incorporated herein by reference in its entirety.

### FIELD OF THE DISCLOSURE

The present disclosure relates to the technical field of storage and/or transmission of uncompressed data, for example of video or images, while using a standard format such as the ISOBMF format or any standard specification inheriting from ISOBMFF.

### BACKGROUND OF THE DISCLOSURE

As commonly known, MPEG standards allow storage of video sequences or images, based on a common basis format denoted the ISO Base Media File Format (or ISOBMFF). This is standardized by the International Standardization Organization as ISO/IEC 14496-12. Extensions of this standard, such as ISO/IEC 14496-15, define codec-specific storage formats for video sequences or images encoded with a codec into a bitstream based on NAL (Network Abstraction Layer) units. Video codec specifications, such as AVC (ISO/IEC 14496-10), HEVC (ISO/IEC 23008-2), or VVC (ISO/IEC 23090-3), define types of NAL unit and payloads. In turn, the NALU-based File Format (ISO/IEC 14496-15) defines storage of these NAL units, so that any file format parser compliant with the NALU-based File Format can build a standardized bit-stream that is decodable by a video decoder conforming to the corresponding video codec, for example to AVC, HEVC, or VVC. According to these standards and specifications, the samples (a sample being, for example, an image) are indexed and described in the File Format tracks as encoded samples.

Each sample is described in the metadata part, also called structure-data, of the media file, in sample description boxes (the sample table box (‘stbl’) and its sub boxes and/or track run boxes in fragmented files). The data corresponding to a sample are stored in the media data part of the file, in media data boxes (e.g. ‘mdat’ or ‘imda’). Indexation of the samples mainly consists in providing in the metadata part, or structure-data, of a media file, items of information for accessing sample data stored in the media data part of the file (being noted that this media data part may be in an external file, as permitted by the data reference box, or in the media file itself). Items of information for accessing samples may be sample position (e.g. a byte offset) in the media data box, its size, its timing information, etc.

The standard ISO/IEC 23001-17 aims at offering interoperability for the storage of uncompressed or raw videos, without using NAL units and thus, without offering possibilities of using format-specific compression such as for example AVC, HEVC, or VVC or any video-specific codec. This MPEG standard for uncompressed video storage in ISO Base Media File Format is based on, or inherits, ISOBMFF structure data, i.e. structured into boxes. It is observed that the new boxes proposed in the different embodiments of this disclosure may be part of the ISOBMFF if considered generic enough or may be part of the File Format for uncompressed video.

While such a new standard offers many advantages in terms of compatibility and interoperability, the amount of data may lead to difficulties in terms of storage and transmission.

This means that, while it is important to preserve ISOBMFF features like genericity and wide support by media players as well as the possibility for temporal fragmentation or segmentation, for random access, and multiplexing of different media types (e.g. uncompressed video or image with encoded audio), there is a need to optimize handling of raw data to optimize their storage, transmission or access or retrieval, for example for partial access or partial rendering (for example for accessing specific regions of interest in large images or lines of data block for parallel processing).

To optimize the storage, in terms of size, an amendment to ISO/IEC 23001-17 is considering applying a generic lossless compression to uncompressed data. This saves storage space or transmission bandwidth while preserving the data. The generic compression is applied to “parts”, “entities” or “extents” of the data that may correspond either to a full image (an item or a sample), a tile, a row of pixels or a pixel (it being noted that other types of entities may be used depending on the media format in use). These entities actually correspond to a byte range in the data part of the encapsulated file.

The algorithms used to perform the generic compression are well-known and widely supported (e.g., deflate, zlib, LZMA, Brotli, etc.). The items of information describing the generic and lossless compression are described in the above cited amendment as a metadata structure (a box) called Compression Configuration Box that is provided in encapsulated files with the sample description (or item properties in case of still images).

While such formats appear to be efficient, there is a constant need for improvement.

### SUMMARY OF THE DISCLOSURE

The present disclosure has been devised to address one or more of the foregoing concerns.

In this context, there is provided a solution for improving storage or transfer or retrieval or access of uncompressed data while using a standard format.

According to a first aspect of the disclosure, there is provided a method of encapsulating media data as samples into a media file comprising at least one media data part and at least one metadata part, by a processing device, the method comprising:
generating, based on the media data, at least one sample; and
generating metadata in the at least one metadata part, the generated metadata describing each byte-range of a sequence of byte-ranges of media data of the at least one sample,
   wherein metadata describing at least one byte-range of the sequence refer to media data of at least another byte-range previously described in the metadata.

Accordingly, the method of the disclosure makes it possible to store uncompressed data in an interoperable and efficient way and to preserve features of the standard used, for example to preserve ISOBMFF features such as random access, fragmentation, and data multiplexing, while offering some flexibility to access to various data blocks or data parts. The method applies to images of a sequence of images and to individual images.

According to some embodiments, the at least another byte-range is at least a part of another byte-range of the at least one sample.

Still according to some embodiments, the at least a part of another byte-range is of a run of samples comprising the at least one sample.

Still according to some embodiments, the method comprises processing at least one entity, the processed at least one entity corresponding to at least one byte-range of the sequence. The processing may comprise applying a generic compression to the at least one entity and/or encrypting the at least one entity.

Still according to some embodiments, the metadata comprise an indication of the processing applied to the at least one entity.

Still according to some embodiments, the metadata comprise an indication of a size of the at least one sample, the size of the at least one sample being determined as a function of the at least one processed entity.

Still according to some embodiments, the metadata comprise an indication of a size of the at least one sample, the size of the at least one sample being equal to a size of all of the byte-ranges of the at least one sample, that metadata do not refer to media data of another byte-range.

Still according to some embodiments, the metadata describing a byte-range comprise an indication of the size of the byte-range, an offset indicating the first byte of the byte-range being determined as equal to zero or as equal to the sum of all the sizes of previously described byte-ranges of the at least one sample.

Still according to some embodiments, the metadata describing a byte-range comprises an offset from the start of the at least one sample and a size.

Still according to some embodiments, the at least one sample is at least one item corresponding to at least one individual image or at least one sample corresponding to at least one image of a sequence of images.

According to a second aspect of the disclosure, there is provided a method of parsing a media file encapsulating media data as samples, by a processing device, the media file comprising at least one media data part and at least one metadata part, the method comprising:
obtaining, from the at least one metadata part, metadata describing each byte-range of a sequence of byte-ranges of at least one sample, metadata describing at least one byte-range of the sequence referring to media data of at least another byte-range previously described in the metadata and
determining media data corresponding to the at least one sample as a function of the at least a part of the other byte-range.

Accordingly, the method of the disclosure makes it possible to store uncompressed data in an interoperable and efficient way and to preserve features of the standard used, for example to preserve ISOBMFF features such as random access, fragmentation, and data multiplexing, while offering some flexibility to access to various data blocks or data parts. The method applies to images of a sequence of images and to individual images.

According to some embodiments, the at least another byte-range is at least a part of another byte-range of the at least one sample.

Still according to some embodiments, the at least a part of another byte-range is of a run of samples comprising the at least one sample.

Still according to some embodiments, the method comprises processing at least one byte-range of the sequence, the processed at least one byte-range corresponding to corresponding media data. The processing may comprise applying an inverse generic compression to the at least one byte-range to be processed and/or decrypting the at least one byte-range to be processed.

Still according to some embodiments, the metadata comprise an indication of the processing to be applied to the at least one byte-range to be processed.

Still according to some embodiments, the metadata comprise an indication of a size of the at least one sample, the size of the at least one sample being equal to a size of all of the byte-ranges of the at least one sample, that metadata do not refer to media data of another byte-range.

Still according to some embodiments, the metadata describing a byte-range comprises an indication of the size of the byte-range, an offset indicating the first byte of the byte-range being equal to zero or to the sum of all the sizes of previously described byte-ranges of the at least one sample.

Still according to some embodiments, the metadata describing a byte-range comprises an offset from the start of the at least one sample and a size.

Still according to some embodiments, the at least one sample is at least one item corresponding to at least one individual image or the at least one sample is at least one sample corresponding to at least one image of a sequence of images.

Still according to some embodiments, the media file is an ISO Base Media File Format (ISOBMFF) standard compliant file.

According to other aspects of the disclosure, there is provided a processing device comprising a processing unit configured for carrying out each step of the methods described above. The other aspects of the present disclosure have optional features and advantages similar to the first and second above-mentioned aspects.

At least parts of the methods according to the disclosure may be computer implemented. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present disclosure may take the form of a computer program product embodied in any tangible medium of expression having computer usable program code embodied in the medium.

Since the present disclosure can be implemented in software, the present disclosure can be embodied as computer readable code for provision to a programmable apparatus on any suitable carrier medium. A suitable tangible carrier medium may comprise a storage medium such as a floppy disk, a CD-ROM, a hard disk drive, a magnetic tape device or a solid-state memory device the like. A suitable transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Other features and advantages of the disclosure will become apparent from the following description of non-limiting exemplary embodiments, with reference to the appended drawings, in which:

FIG. 1 schematically illustrates encapsulation and parsing of images or sequences of images to be transmitted, according to some embodiments of the disclosure;

FIG. 2 illustrates an example of steps of an encapsulation process according to some embodiments of the disclosure;

FIG. 3 illustrates an example of steps of a parsing process according to an embodiment of the disclosure;

FIGS. 4 and 5 illustrate examples of indexing compressed entities for samples or items according to the embodiments described by reference to FIG. 2;

FIG. 6 illustrates an example of using properties associated with byte-ranges of sample for indexing compressed entities of samples;

FIG. 7 illustrates an example of metadata part and box structure to describe uncompressed samples that are generically compressed; and

FIG. 8 schematically illustrates a processing device configured to implement at least one embodiment of the present disclosure.

### DETAILED DESCRIPTION OF EMBODIMENTS OF THE DISCLOSURE

According to some embodiments of the disclosure, uncompressed or raw data are stored or transmitted along with their description, possibly applying a non-destructive (lossless) compression and/or processing on data blocks (or entities, or extents) and conforming to a standard format such as ISOBMFF, with data mutualization.

According to some embodiments, a data block, an entity or an extent may be considered as a support for the generic compression, that is to say a compression unit. In other words, a compression unit corresponds to a piece of data onto which a generic compression algorithm may be applied. When the generic compression is applied, the result may be referred to as a “compressed unit”, a “compressed entity”, a “compressed extent” or a“compressed byte range” (each of these terms may be used each of these terms can be used interchangeably to designate the same object), to distinguish it from the original part, entity or extent of the uncompressed data. Each data block, entity or extent may be compressed individually (and then further processed or decompressed individually when used). Depending on configuration parameters, for example encapsulation configuration parameters, or depending on requirements of the applications requesting storage, access and/or transmission of the data, a data block or entity of a given type may correspond to one or more data blocks of this given type. This may be used to improve compression efficiency by applying the generic compression to a set of entities, for example two consecutive tiles or several rows of pixels, having similar values. Likewise, when entities of uncompressed data have the same values, it may be advantageous to use one compressed entity to represent all these entities with the same values.

Accordingly, the data storage cost or the transmission cost may be reduced since a portion of the uncompressed data is stored or transmitted as generically compressed while preserving file format features such as interoperability, random access, ability for streaming or progressive download, genericity and data multiplexing. It is to be noted that encryption to protect media data may also be applied on each compressed entity individually. Some compressed entities may be encrypted while others remain in clear, for example encrypting critical or sensitive areas in surveillance data or spatial imagery, or to preserve privacy. The encryption may be the one standardized as ISO/IEC 23001-7, named Common Encryption (CENC).

Since the generic compression can be applied to different entities, possibly independently, some embodiments are directed to describing these entities to enable data decoding, rendering or transmitting, based on these entities (and not necessarily on a whole image or frame). Such entities may be components, tiles, blocks of rows, rows, pixels, and more generally any entities structuring the data.

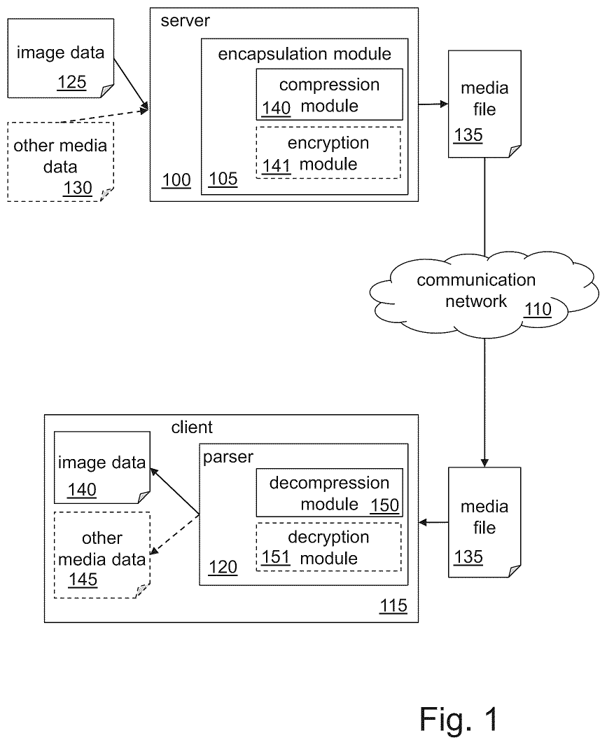

FIG. 1 schematically illustrates encapsulation and parsing of images or sequences of images to be transmitted, according to some embodiments of the disclosure.

As illustrated, a server 100 comprises an encapsulation module 105. The server 100 may be connected, via a network interface (not represented), to a communication network 110 to which is also connected, via a network interface (not represented), a client 115 comprising a parser (or de-encapsulation module) 120 or a storage device (not represented). Optionally, the server 100 may comprise an encryption module 141 to encrypt sensitive parts of or the whole data, preferably after compression. Likewise, the client 115 optionally comprises a decryption module 151 to decrypt sensitive parts of, or the whole data that have been previously encrypted. Preferably, the decryption is done before decompression. The exact order may also be indicated by indicating in an Essential descriptions hierarchy sample grouping (‘esgh’). It is to be noted that encryption and decryption modules may be contained in other processing modules external to server 100 and client 115, respectively.

According to the given example, server 100 processes data 125, for example video and/or sequence of image data, for streaming or for storage. Server 100 may also receive other media data 130, for example of the text or audio type and/or encoded video bit-streams, and/or metadata (not represented), wherein encoded data may be data compressed with a media-specific compression scheme. These other media data and these metadata may be either in an encoded or in an uncompressed format, it being noted that some of these data may be in a encoded format and others may be in an uncompressed format.

For the sake of illustration, image data 125 may correspond to the recording of a scene by one or several cameras (or image sensors), referred to as a video source (i.e. a source of sequences of images), or may correspond to the recording of images without temporal information, obtained from an image source (i.e. a source of individual images or untimed images). Since image data 125 are uncompressed, they are also called raw data. Server 100 may index or describe the images of the video source into a media file 135 or into segment files (containing one or more segments), as they are processed, for example for live recording or live transmission. Likewise, server 100 may index or describe the images of an image source into a media file, for example into media file 135 as they are processed. The individual images or untimed images of the image source are referred to as media data items or more precisely as image items, for example as defined in HEIF (High Efficiency Image Format, ISO/IEC 23008-12) standard. In other words, an image item represents image data that does not require timed processing, as opposed to sample data, and is described by the boxes contained in a MetaBox.

Although the images of a sequence of images may be referred to as samples and individual images may be referred to as items, the term “sample” may be generically used for designating either an image of a sequence of images or an individual image (it being noted that the metadata structure for samples (e.g., ‘moov’ and ‘trak’ boxes) is different from the one for items (e.g., ‘meta’ box)).

According to some embodiments of the disclosure, a compression module referenced 140 applies a generic (media agnostic or media independent) and lossless (at least visually lossless) compression to image data 125. Such compression is preferably a commonly used lossless compression, for example a compression complying with the known DEFLATE compression algorithm (other examples of commonly used lossless compression algorithms are the bzip2, the Izma, and the Brotli compression algorithms). The compression algorithm used is a generic compression, i.e. format agnostic, in opposition to media-specific compression or encoding such as audio codecs (e.g. mp3 and AAC), video codecs (e.g. AVC, HEVC, and VVC or non-MPEG video codecs), or image codecs (JPEG, JPEG-2000, HEVC, etc.).

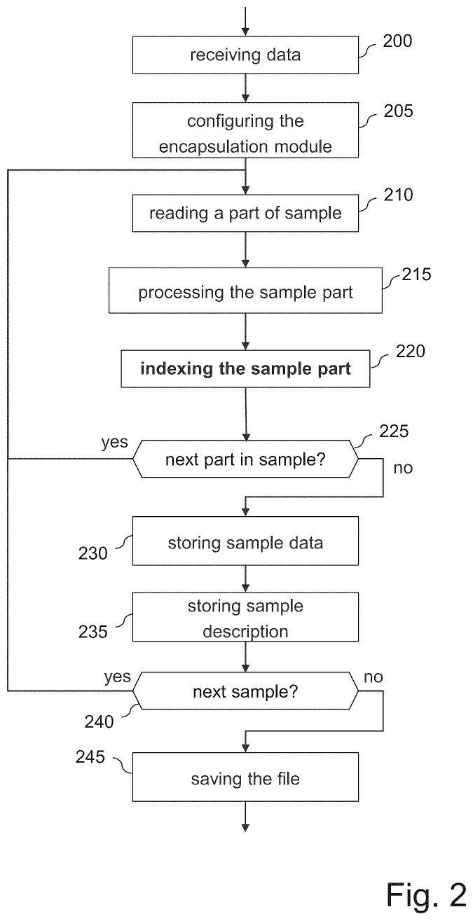

An example of steps for indexing generically compressed samples is described by reference to FIG. 2 (that applies similarly to items).

The media file 135 or the generated segment files may be stored in a local or remote storage device or may be transmitted to a client, for example to client 115.

Client 115 may be configured to process data received from communication network 110, for example to process media file 135, or to process data read from a storage device. After the received or the read data have been parsed in parser 120 (also known as a de-encapsulation module or a reader, or even a player or a media player), the parsed data may be stored, displayed or output. According to the given example, the parser outputs the uncompressed video or images referenced 140, possibly with additional media data, such as media data 145, for example of the text or audio type and/or encoded video bit-streams, and/or metadata. These additional media data 145 form one or several bit-streams that may be displayed.

It is observed that some of the data of the received or read data, for example some data of media file 135, may be generically compressed data blocks or generically compressed entities, resulting from the generic compression of either samples, chunk of samples, time range, fragment, segment or parts of a sample like tile, row of pixels, etc. To be rendered or processed, these compressed data blocks or compressed entities require decompression. This decompression can be performed by the decompression module 150 in client 115.

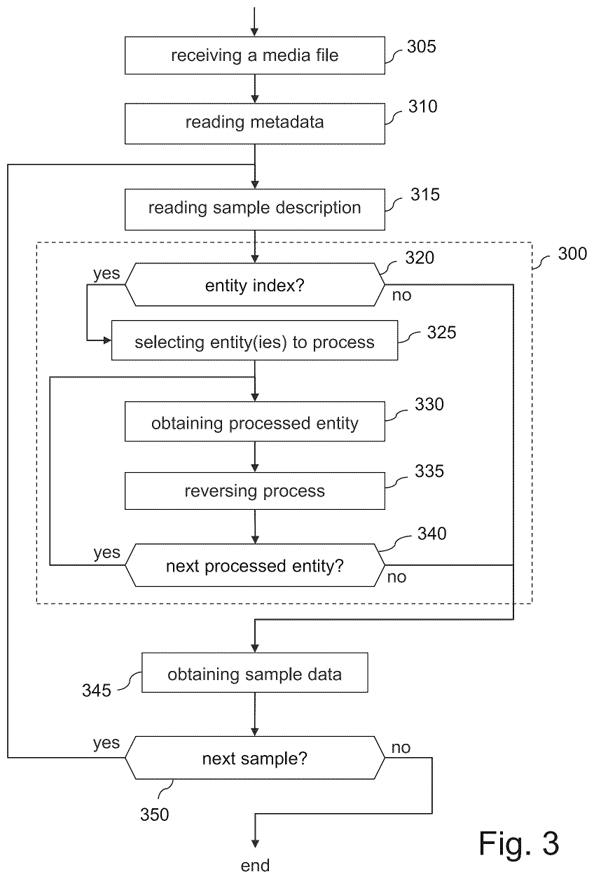

An example of steps for decompressing indexed samples is described by reference to FIG. 3 (that applies similarly to items).

It is observed that server 100 and client 115 may be user devices but may also be network nodes acting on media files being transmitted or stored.

It is also noted that media file 135 or any other media file received or read by client 115 may be communicated to parser 120 in different ways. In particular, encapsulation module 105 may generate media file 135 with a media description (e.g. a DASH MPD, i.e. a media presentation description (MPD) of the dynamic adaptive streaming over HTTP (DASH) protocol) and may communicate (or stream) it directly to parser 120 upon receiving a request from client 115. Media file 135 may also be downloaded, at once or progressively, by client 115 and stored locally.

For the sake of illustration, media file 135 may encapsulate media data (e.g. uncompressed or encoded video, possibly with additional media data) into boxes according to ISO Base Media File Format (ISOBMFF, ISO/IEC 14496-12).

In such a case, media file 135 may correspond to one or several media files or segments (indicated by a FileTypeBox ‘ftyp’ or a SegmentTypeBox ‘styp’). According to ISOBMFF, media file 135 may include two kinds of boxes, one or several “media data boxes” (e.g. ‘mdat’ or ‘imda’), containing the media data, and “metadata boxes” or “structure-data wrapper” (e.g. ‘moov’ or ‘moof’), containing metadata defining the position of the media data in the media data box(es) and temporal position of the media data.

For example, the media data box(es) contain all the data for image data 125 and all the data for possible other media data 130. There may be one media data box multiplexing media data 130 and media data 125, for example compressed media data 130 and uncompressed media data 125. Alternatively, there may also be several media data boxes, for example a first set of media data boxes for the compressed media data and a second set of media data boxes for the uncompressed data.

According to some embodiments of the disclosure, the encapsulation comprises indexing parts of samples that have been generically-compressed as compressed data blocks or compressed entities, as described by reference to FIG. 2. In a symmetrical way, processing the encapsulated data in a reader comprises processing compressed data blocks or compressed entities, possibly individually, based on indexing formation and then parsing sample description to extract and reconstruct the samples or parts of samples, as described by reference to FIG. 3.

For the sake of illustration, the description is based on processing samples, but it is to be noted that similar processes apply to items.

### Generic Compression and Indexing of Compressed Entities

FIG. 2 illustrates an example of steps of an encapsulation process according to some embodiments of the disclosure. According to this embodiment, each of the elements onto which the generic compression is applied, on an individual basis, is a part of a sample, denoted an entity or an extent. The illustrated steps may be carried out in an encapsulation module, for example in encapsulation module 105 in FIG. 1.

According to the illustrated example, the encapsulation module to be used is configured (step 205) after having received uncompressed or raw data in step 200. Such a configuration step may comprise setting encapsulation options such as setting parameters indicating whether the file is fragmented or not, whether there is single file or segments, whether there is a single media data box or several, whether the data are multiplexed if other media data (such as media data 130 in FIG. 1) are to be encapsulated in the same file, etc. The settings may be set by a user through a graphical user interface or through a command line. Alternatively, these settings may be hard-coded in the server wherein the media data are encapsulated. According to some embodiments, configuration of the encapsulation module comprises configuration of the compression module such as compression module 140 in FIG. 1, for example by activating the compression algorithm and defining the part(s) of samples or image items onto which this compression algorithm is applied. This may be indicated in a compression configuration box in the metadata part of the media file 135.

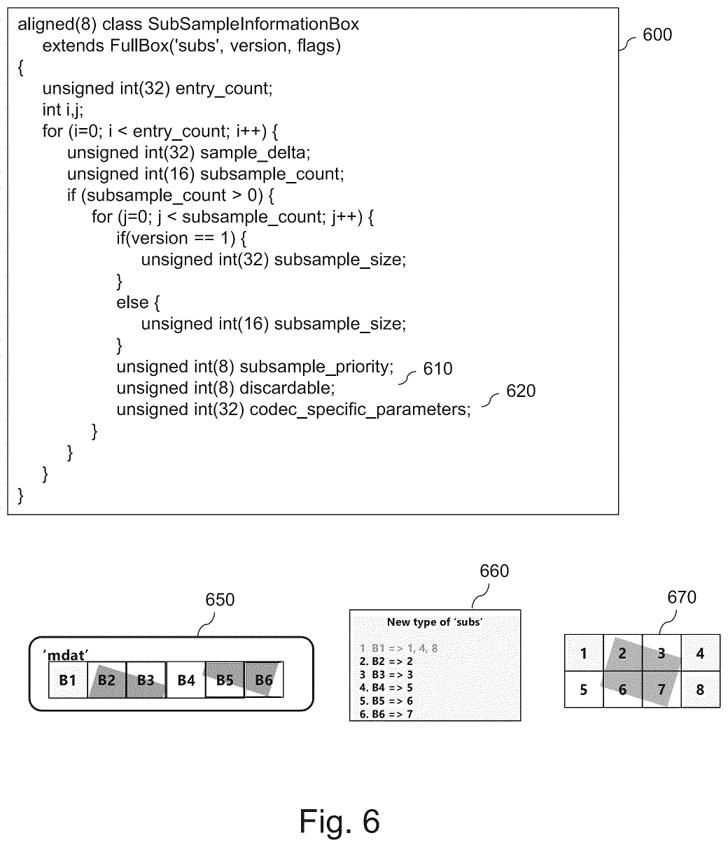

The settings may also comprise further items of information for optimizing the storage of uncompressed data by allowing byte range mutualization. This can be useful to store as one compressed byte range or one compressed entity the compressed data corresponding to at least two entities having the same values. For example, the ability to reuse a byte range several times in a sample, typically to carry only once the pixels corresponding to dead zones in an image (e.g. after rotation) may reduce data storage or transmission cost. In other words, a compressed entity of a sample can reuse parts of the sample data by pointing to the same data using the same entity_offset. In such a case, their compressed representation would also be the same sequence of bytes and could be stored once in the file. FIG. 7 illustrates an example of metadata part and box structure to describe uncompressed samples that are generically compressed. In this example, the compression configuration box is the box referenced 754. The different values allowed for the compression_type of the compression configuration box may be extended with an additional mode indicating that actually no compression is performed (i.e., an identity transformation), for example as follows:

| Value | Description |
|---|---|
| ‘defl’ | DEFLATE algorithm as defined in IETF RFC 1951 |
| ‘zlib’ | DEFLATE algorithm as packaged in the format defined by |
| | IETF RFC 1950 |
| ‘brot’ | Brotli algorithm as defined in IETF RFC 7932 |
| ‘iden’ | Identity (no compression but possibly byte range mutualization) |

Likewise, the list of predefined values for the compression entity type (compressed_entity_type field of the compression configuration box) offer no way of signaling whether a range for a compressed entity contains a single entity as identified by the compression entity type of the CompressionConfigurationBox, or multiple ones.

The list of predefined values for the compression entity types in the following table could be made explicit by stating “the entity shall be a single entity of the given type” instead of“the entity is of a given type”. In a variant, there may be distinct values reserved for the single entity type and for the multiple ones, for example, value 1 for a single component and a new value 6 for multiple components, etc.

| Value | Description |
|---|---|
| 0 | the entity is the full item or sample |

Image-related types

| | |
|---|---|
| 1 | the entity is the full image for a given component |
| | (component-based interleave and mixed interleave) |
| 2 | the entity is a tile |
| 3 | the entity is a row |
| 4 | the entity is a pixel |

Other types

| | |
|---|---|
| 5 | the entity is a single KLV-encoded key |
| other values | ISO/IEC reserved for future definition |

The Compression Configuration Box (754) may be extended with the following additional field to introduce more flexibility:
unsigned int(16) num_entities
   where num_entities is an integer indicating the number of entities compressed together in a single compressed range described by one compressed_entity_info. If value is set to 0, the number of entities within each compressed range is unknown. Otherwise, when set for example to N, each compressed_entity_info describes exactly N entities.

During its configuration (step 205), the encapsulation module starts creating the media file with the top-level metadata boxes, for example the following metadata boxes when ISOBMFF is used: FileTypeBox (‘ftyp’) or SegmentTypeBox (‘styp’) (for segments), MovieBox (‘moov’) and optionally MovieFragmentBox (‘moof’) if the media file is configured for fragmentation. The ‘ftyp’ or ‘styp’ box may contain a brand value indicating that one or several generic compression algorithms are used for the storage of samples data (either as major_brand or in the list of compatible brands). When the data read in step 200 correspond to still images, the metadata part is indicated under a top-level ‘meta’ box. When the data read in step 200 correspond to a sequence of images or a video, the metadata part is indicated under a top-level ‘moov’ box, possibly followed by zero or more ‘moof’ top-level boxes, depending on encapsulation settings. The sample description can be initialized in step 205 by creating, for video, a sample table box ‘stbl’ and sample entries or, for still images, an item information box ‘iinf’ and item properties to describe the items. A specific four-character code (4cc) is defined and reserved for indicating that samples or items correspond to uncompressed image data. For example, the four-character code ‘uncv’ may be used for a track of “uncompressed video”, e.g., as coding name of a sample entry or as data_format in the OriginalFormatBox ‘frma’ of a restricted sample entry and ‘unci’ may be used for items, as item_type value in an ItemInfoEntry box (‘infe’). When generic compression is applied to samples, they are preferably described using a restricted sample entry, indicated by the 4CC ‘resv’. This informs parsers that some operations have to be done on the samples before resulting in actual uncompressed video. The 4CC used for indicating that read data correspond to uncompressed video may be indicated in the existing OriginalFormatBox (‘frma’) within a RestrictedSchemeInfoBox (‘rinf’) having a scheme type value indicating that generic compression is in use, for example the 4CC ‘gcmp’.

Additional parameters within this restricted sample entry may further describe the samples, for instance a compression configuration box may provide the type of generic compression applied to data stored in samples (e.g. “gzip”, “compress” or “deflate”). Having a generic sample entry type or item type (‘uncv’ or ‘unci’) on the one hand and metadata indicating generic compression or not on the other hand, allows to support storage of uncompressed samples in a unified way, whatever their pixel configuration and whether compression is applied or not, and independently of the type of compressed entities. Applying a generic compression on a sample or an item (or a part thereof) results in a generically compressed sample or item, which may be a sample or an item that is compressed using one of a defined set of off-the-shelf numerically and bitwise lossless compression capabilities. The compression in use may be indicated in the compression configuration box in the sample description (754). Moreover, the sample entry type for uncompressed videos or images may be used in the codecs parameter for the MIME type of the file. Such a file may be seen as a whole as a media file containing uncompressed video (or image). The fact that compression is applied or not may come as an additional parameter, through a brand or an additional parameter as explained later in this description.

Similarly, a specific four-character code may be used as an item_type value in an ItemInfoEntry box to indicate that an image item is an uncompressed image. In addition to this item_type, a compression configuration property may be associated with an uncompressed image item to further detail the compression parameters. The payload for this property may be the same as the one for compression configuration box, possibly with a reduced set or a different set of values for indicating the type of the compressed entities.

After being configured, the encapsulation module may begin reading part of the sample data (step 210). In the case of uncompressed videos or uncompressed still images, the sample data correspond to a frame or an image, respectively. The part to read is determined by the encapsulation settings, in particular the type of compressed entities (e.g., a full sample or item, a full image for a given component, a tile, a row of pixels, a pixel, etc.).

Next, if a generic compression is to be applied, the read sample data are processed during step 215, by using the lossless generic compression algorithm selected during the configuration of the encapsulation module. For the sake of illustration, the DEFLATE algorithm may be selected by default. According to some embodiments, the processing step 215 may comprise applying a generic compression, applying a generic compression followed by an encryption or applying a data mutualization with or without compression and with or without encryption. The size of the data obtained after processing the part of the sample is kept in memory to compute the sample size that is written in sample description. Next, the processed part of the sample is indexed in a metadata structure for compressed entities within the hierarchy of sample description boxes to provide temporal position, optionally byte offsets, and sizes of the processed sample (step 220).

The encapsulation module then iterates on following parts of the sample (step 225). When the last part is processed, the sample description is finalized, the corresponding sample data are stored in the data part of the file (step 230) and the sample description is stored in the metadata part of the file (step 235). During this step, the sample size, as documented by the SampleSizeBox or in TracKRunBox, should be the size of the compressed parts described by the index for compressed entities 770, i.e. it should be equal to MAX(offset+size) of any compressed entities in the sample. If no compressed entity is present for a sample, the entire sample payload is actually the compressed entity, i.e. an implicit entity is defined with an entity size equal to the sample size and an entity offset equal to 0. Likewise, when used for still images represented by items, the item size in bytes is the size of the compressed material described by the index for compressed entities, possibly as an item property equivalent to CompressedItemEntitiesInfoBox (770), i.e. the item size should be equal to MAX(offset+size) of any compressed entity in the item. This size should be equal to the sum of all extent_length of the extents describing this item in an ItemLocationBox (‘iloc’). If this property is not associated with an item using generic compression, the entire item is the compressed entity. It can be noted that if some compressed parts of the compressed sample are mutualized during this process, the sample size documented by the SampleSizeBox is less than the size of the compressed sample before encapsulation and may be less than the size of the reconstructed sample. All samples in a track or in a track fragment should be documented in the index for compressed entities, e.g. the CompressedEntitiesInfoBox (770). (It is to be noted that the CompressedEntitiesInfoBox is depicted within a SampleTableBox on FIG. 7, but it could also be contained in a TrackFragmentBox, when indexing a run of samples from a movie fragment).

Within a sample or item, it is possible to mutualize identically compressed data by using the same entity offset and size as a previously described entity. For items, an item may reuse parts of another item using the extent construction mechanisms. To avoid breaking HEIF implementations, when applied to still images represented by image items, the index for compressed entities preferably keeps the offsets within the image item range. It is to be noted that the item data can be reused through the extents mechanism of item construction: the bytes for a compressed entity should be contained in a single item extent. One item extent may however contain more than one compressed entity.

It is to be noted that for a given sample, compressed entities do not have to be listed in a particular order; derived specification may further constrain this, for example to describe entities in increasing order of offsets.

In the case of image items, for example when the data received in step 200 to introduce more flexibility correspond to one or more images, encapsulated as one or more image items, an equivalent metadata structure to the index in the sample description may be generated as an item property to provide sizes and optionally offsets of the compressed (or processed, e.g. encrypted, or with byte ranges being mutualized) entities. Instead of a dedicated property, an item location box with a construction method allowing the use of extents can also be used, where a compressed entity would map to an extent in the item location box. In a case according to which it exists a one-to-one mapping between an extent in an item location and an entity of an item, a specific value for a construction method could be used (for example construction_method=3). This would be an indication for parsers that the length of an extent is assumed to be the size of a compressed or processed entity declared in the index for compressed or processed entity (e.g. an item property equivalent to the box 770). The so-built property or box may be inserted in the media file providing the item byte offset and length during step 220. The data for the compressed entities of the item are then appended to a media data box (e.g. ‘mdat’ or ‘imda’ box) in step 230 and the item description is written at step 235.

Next, a test is performed to check whether there is a next sample (or item) to process (step 240). If there is a next sample (or item) to process, the algorithm loops on step 210 to process the next sample (or item). Otherwise, the metadata describing the media data is finalized and the media file is saved (step 245) for storage and/or transmission. The obtained media file (e.g., media file 135 in FIG. 1) may be stored as one single file or as multiple segment files.

### Parsing of Generic Compressed and Indexed Entities

FIG. 3 illustrates an example of steps of a parsing process according to some embodiments of the disclosure, wherein the support for the generic compression corresponds to a full sample (i.e. a picture or an image, for example a picture or an image from input data 125 in FIG. 1), to a full image for a given component, to a tile, to a row of pixels, to a pixel, etc. or to any structure from the data indicated in a compression configuration box or item property or equivalent metadata structure describing the compression. Such steps may be carried out by the parser 120 in FIG. 1.

As illustrated, a first step (step 305) is directed to receiving a media file or segment files. Next, it is determined (step 310), for example in the ‘ftyp’ box (or the ‘styp’ box), whether or not some brands (major, minor, or compatible brands) indicate that a generic compression and/or encryption or processing has been applied to samples or parts of samples (or to items or parts of items). If no brand provides such indication, the media file may be further inspected to determine whether a generic compression and/or encryption or processing has been applied to samples or parts of samples (or to items or parts of items), for example the sample description for uncompressed video data or uncompressed image sequence or in the case of uncompressed images the item properties may be inspected (step 315).

From the sample description, in particular from a sample entry, the parser may determine (step 320) whether the sample has been processed in parts (or entities) or not, for example by looking in the metadata part of the media file for a box (e.g., 754 or 770 in FIG. 7) or for an item property indexing compressed entities. If none is found, the parser processes the file on a sample basis. If an indication is found, the media file may be processed on a compressed entity or processed entity basis. The parser then selects, for example from application settings or from user selection, one or more entities to process (step 325). This selection is optional, for example when the parser is configured to process images or samples on a tile or on blocks of rows basis, for example for parallelisation purpose. Indeed, for parallelisation, there may be several occurrences of parsers (e.g., several parsers 120 in FIG. 1), each processing a different part of the data. The parser may also process all the entities by default so as to reconstruct the original video sequence or image(s) data (e.g., image 135 in FIG. 1). From the compressed entity index, the parser retrieves (step 330) the data corresponding to the set of compressed (or processed) entities to process or reconstruct. The data may be retrieved in the data part of the media file from indicated size and possibly offset (when present) information for the current compressed (or processed) entity.

Depending on an indication of compression, encryption and/or byte mutualization, from the compression configuration box (or property for items), the parser appends to a memory the data resulting from the reverse-processing of the compressed entity (step 335). The reverse-processing here may correspond to a decompression of the compressed entity, to the decryption of a compressed entity or to a copy of a byte range when it has been mutualized or any combination of those. Preferably, the combination is done in that order: copy, then decryption if needed, then decompression. When an essential descriptions hierarchy sample grouping (‘esgh’) is present, the reverse-process simply follows the operations indicated in the sample group description entry the sample is mapped to. Once all the selected entities have been reverse-processed (step 340), the concatenation of the corresponding byte ranges lead to the reconstructed uncompressed video frame for the current sample or to an uncompressed image and the data for a sample or item are obtained (step 345). They can be stored or transmitted to a module or an application using the data (not represented). The parser iterates until all the samples (or items) have been processed (step 350).

It is observed that for the sake of clarity, parsing of classical audio or video tracks is not described here. However, it should be understood that the uncompressed data obtained from the parser or reader, for example the image data 140 in FIG. 1, may be rendered with additional media data such as media data 145 in FIG. 1. For example, uncompressed video corresponding to image data 140 in FIG. 1 may be rendered with synchronized audio corresponding to media data 145 in FIG. 1 or individual images corresponding to image data 140 in FIG. 1 may be rendered with text annotations corresponding to media data 145 in FIG. 1.

The embodiments described by reference to FIGS. 2 and 3 make it possible for encapsulation modules to indicate that a media file contains uncompressed video samples or uncompressed images in a first parameter of the sample description (e.g. a sample entry type or a data_format in the OriginalFormatBox ‘frma’ of a restricted sample entry) and, in a second parameter, an indication whether it has been processed as a whole sample (or item) or as one or more entities. By parsing these items of information from the media file, parsers or readers are informed on the kind of data they will produce and on possible preliminary decompression and/or reconstruction steps to perform before providing the sample (or item) data to a renderer.

### Example of Index for Compressed Entities, Sample-Based

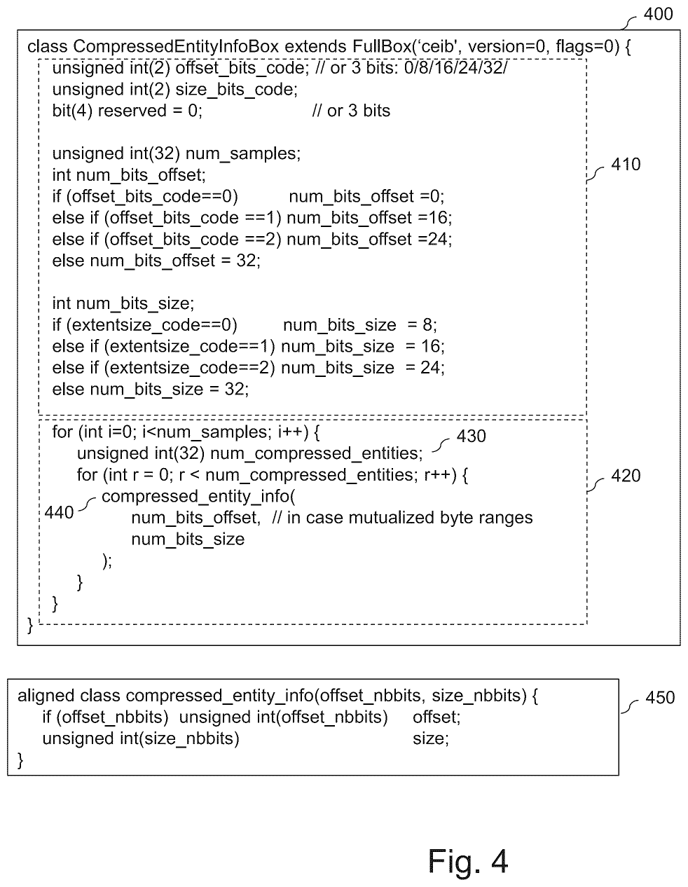

FIG. 4 illustrates an example of indexing compressed entities for samples or items according to the embodiments described by reference to FIG. 2. It is a possible representation for the box 770 in FIG. 7. The name of the box 400 and corresponding 4CC is given as an example (any reserved code dedicated not conflicting with existing ones may be used). This box provides (in 420 or 450) sizes in bytes for compressed (or processed) entities, optionally with a byte offset in the data part of the media file (e.g. a media data box). The offset starts from the first byte of the sample deduced from sample to chunk and chunk offset information boxes in the sample description. In other words, the offset in 450 is the offset in bytes to the first byte of the compressed entity from the start of the sample data as stored in the file. The offset is preferably indicated as an unsigned integer since the offset is always within the range of the sample (or item) payload. The size of the compressed entity indicated in 420 or 450 should not be 0. For compliance with current ISO/IEC 14496-12 specification, offset and size fields do not use 64 bits because it would be out of the range defined for a sample size (indicated with 32 bits). A first set of parameters 410 is directed to defining the number of bits onto which the offsets and sizes information, for the processed or compressed entities, are coded in the parameters referenced 420 and 450. In a variant, the number of bits in use could be indicated by a combination of flags values. In another variant, both offset and size fields are encoded using the same number of bits, thus removing half of the parameters in the set 410. As another variant, the compression configuration box has a parameter or a compression type indicating that data mutualization is in use or not. The block of parameters 420 represents the indexing information with a loop on entries that actually corresponds to a loop on samples, the number of samples being indicated within the list of parameters 410. This index indeed uses a single loop on samples, instead of a double loop, since all samples are likely to have different entity offsets and sizes. For each sample, a number of compressed entities for this sample is indicated by parameter 430. The parameter 430, denoted for example num_compressed_entities, is an integer that indicates the number of compressed entities for the item or sample. This value shall not be 0. An inner loop provides, for each compressed entity, size information and, optionally offset information (when num_bits_offset is different from zero). When the parameter num_bits_offset is equal to 0, it means that there is no offset encoded and thus, that the offset should be inferred to be zero by parsers for the first compressed entity and to be the sum of all entity_size values of all the preceding compressed entities of the sample otherwise (for following compressed entities). Then, the data for the compressed entities are considered as contiguous and the sample (or part of the sample, depending on entity selection in step 325 in FIG. 3) may be reconstructed by, for each compressed entity,
locating data in the media data box at the current sample data offset,
obtaining a number of bytes equal to the size parameter indicated in parameters 440 (or 450),
applying the decryption when present and the decompression as indicated in the compression configuration box 754 in FIG. 7,
appending the obtained data in a buffer, if the compressed entity is in the list of selected entities,
iterating the byte obtaining step and the optional decryption and the decompression for each entity in the inner loop 420 in FIG. 4, and
making available the buffered data corresponding to the reconstructed sample (or part of the sample, depending on entity selection in step 325 in FIG. 3) to an application or module processing it.

When an offset parameter is encoded in parameter 440, i.e., when num_bits_offset is greater than 0, this means that the byte ranges for the compressed entities may not be contiguous or some may have been mutualized. The reconstruction of a sample then requires seeking to the indicated offset, from the start of the current sample before obtaining the number of bytes indicated by the size parameter in parameter 440. The other above-described steps apply.

In a variant, the number of compressed entities 430 is described once out of the loop 420 on entries. This index is compliant with the sample description and sample storage as defined by ISOBMFF, and contiguous byte ranges for sample data or for a chunk (i.e. a contiguous set of samples for one track).

Based on the example box configuration of FIG. 7, a hypothetical reconstruction model for a file reader to reconstruct a complete generically compressed item or sample should be equivalent to the result of the following process:
identifying whether a generic compression is used, for example by checking
   the presence of CompressionConfigurationBox associated property for an item (not represented),
   the presence of a ‘resX’ sample entry transformation (740) with a scheme type ‘gcmp’ (752), implying a CompressionConfigurationBox (754) in the SchemeInformationBox (753). Preferably, the scheme version of the SchemeTypeBox (752) is set to 1,
identifying the compression type and entity mode in the CompressionConfigurationBox 754,
extracting the item or sample payload as for any uncompressed item or payload, using extents for items and sample size and offsets for media tracks,
decrypting the entire sample payload as defined in Common Encryption specification if Common Encryption applies to the sample,
locating the CompressedItemEntitiesInfoBox (not represented) for items, or the entry for the given sample in the CompressedEntitiesInfoBox (770) for media tracks,
preparing an empty decompression buffer for the item/sample,
for each compressed entity, in the order they are listed,
   extracting the bytes from the item or sample payload using the entity_offset and entity_size of the compressed entry (440),
   decompressing these bytes using the identified decompressor from CompressionConfigurationBox (754),
   concatenating these bytes into the decompression buffer, and
replacing the item/sample payload with the decompression buffer and update the item/sample size as seen by the application.

This general process may be optimized when being implemented, especially if accessing to a sub-part of the compressed data is possible and desired (e.g. individually compressed tiles), as indicated by the CompressionConfigurationBox (754). In such cases, an implementation can decide to (decrypt and) decompress only the bytes required for its needs.

### Example of Index for Compressed Entities, Chunk-Based

FIG. 5 illustrates another example of indexing compressed entities for samples or items according to the embodiments described by reference to FIG. 2. It is a possible representation for the box 770 illustrated in FIG. 7. The name of the box 500 and corresponding 4CC is given as an example (any reserved code dedicated not conflicting with existing ones can be used). This box provides sizes in bytes for compressed (or processed) entities, optionally with a byte offset in the data part of the media file (e.g. a media data box). The offset starts from the first byte of a given chunk or run (of samples) deduced from chunk offset information box in the sample description, or from the description of the track fragment when the media file is fragmented. A run or chunk of samples is a contiguous set of samples for one track. A first set of parameters 510 is directed to defining the number of bits onto which the offsets and sizes information are coded in the parameters referenced 520 and 560. In a variant, the number of bits in use could be indicated by a combination of flags values. In another variant, both offset and size fields are encoded using the same number of bits, thus removing half of the parameters in the set 510. As another variant, the compression configuration box has a parameter or a compression type indicating that data mutualization is in use or not. The data mutualization may be cross sample here. The block of parameters 520 represents the indexing information with a loop on entries that actually corresponds to a loop on chunks. For each chunk, a number of samples is indicated as illustrated with reference 530, and a number of compressed entities 540 for each sample of a current chunk is indicated. The number of samples should not be greater than the number of entries in the current chunk (or in the current trak fragment run for fragmented media files), this can be determined from the SampleToChunkBox (‘stsc’) (or from the track run box (‘trun’) for fragmented media files). An inner loop then provides, for each compressed entity, a size information optionally with an offset information (when num_bits_offset is different from zero). When the parameter num_bits_offset is equal to 0, it means that there is no offset encoded. Then, the data of the compressed entities are considered as contiguous in the chunk. The samples (or part of the sample, depending on entity selection in step 325 in FIG. 3) can be reconstructed by, for each compressed entity,
locating data in the media data box at the first byte offset of the current chunk, then sample by sample,
obtaining a number of bytes equal to the size parameter indicated in parameters 550,
applying the decryption when present and the decompression as indicated in the compression configuration box 754,
appending the obtained data in a buffer if the compressed entity is in the list of selected entities in step 325 in FIG. 3,
iterating the byte obtaining step and the optional decryption and the decompression for each entity in the inner loop 520 and
making available the buffered data corresponding to the reconstructed samples of the current chunk (or part of the samples, depending on entity selection in step 325 in FIG. 3) to an application or module processing it.

When an offset parameter is encoded in parameters 550, i.e., when num_bits_offset is greater than 0, this means that the byte ranges for the compressed entities may not be contiguous or some may have been mutualized, possibly across samples of a given chunk. Preferably, the offset parameter is constrained to locate data in the chunk to which the current sample belongs. The reconstruction of the samples within a given chunk then requires seeking to the indicated offset, from the start of the current chunk before obtained the number of bytes indicated by the size parameter in parameters 550. The other above-described steps apply. Having a loop on any samples (i.e. mutualizing byte ranges across any samples) would be incompatible with ISOBMFF ecosystem as it breaks sample fetching logic of any existing implementation. It would break sample storage and description in boxes stsz, stsc and stco/co64 for regular files that are mandatory. For fragmented files, it would break the rules on sample data offsets. Likewise, sample auxiliary information storage, especially the storage of the sample auxiliary information offsets would be broken as the offsets could no longer rely on media chunking. In terms of random access, some samples could depend on data that are not included in their usual byte range. Likewise, a random access, when encryption is used, could be broken since sharing data between samples using different Initialization Vectors (and potentially different keys) is not possible unless multiple keys per sample extensions of Common Encryption are used, which may not be desirable for most use cases. In a variant, the offset starts from the first byte of the sample deduced from sample to chunk and chunk offset information boxes in the sample description (or from track run box and sample flags for fragmented media files). In such a case, the offset parameter may be lesser or greater than 0 to locate data in a preceding sample or in the current sample respectively. Possibly, the offset parameter may also indicate data of subsequent samples. Preferably, the offset parameter is constrained to locate data in the chunk to which the current sample belongs. According to this variant, the size of the compressed sample documented in a sample size box ‘stsz’ or ‘stsz2’ is MAX(offset>=0 ?offset+size:0) over all compressed entities of the compressed sample if the offset parameter is constrained to be either lesser than 0 or within the current sample, i.e., between 0 and the sample size documented by a sample size box ‘stsz’ or ‘stsz2’.

In a variant, the number of compressed entities 540 is described once out of the loop 520 on entries, or as another variant before the loop on samples (meaning that the number of entities is constant across the samples of a given chunk). This index is compliant with the sample description and sample storage as defined by ISOBMFF, and contiguous byte ranges for sample data or for a chunk or a run of samples (i.e. a contiguous set of samples for one track).

For the examples of FIG. 4 or 5, the index may contain an additional parameter indicating an offset mode, with for examples two modes: absolute or relative. Absolute indexing is sample-based in the case of FIG. 4 while it is chunk-based in the case of FIG. 5. Relative indexing means a byte offset from the preceding compressed entity (i.e from the last byte given by an optional offset+size).

### Example of Index for Compressed Entities, Based on Subsample Information Box

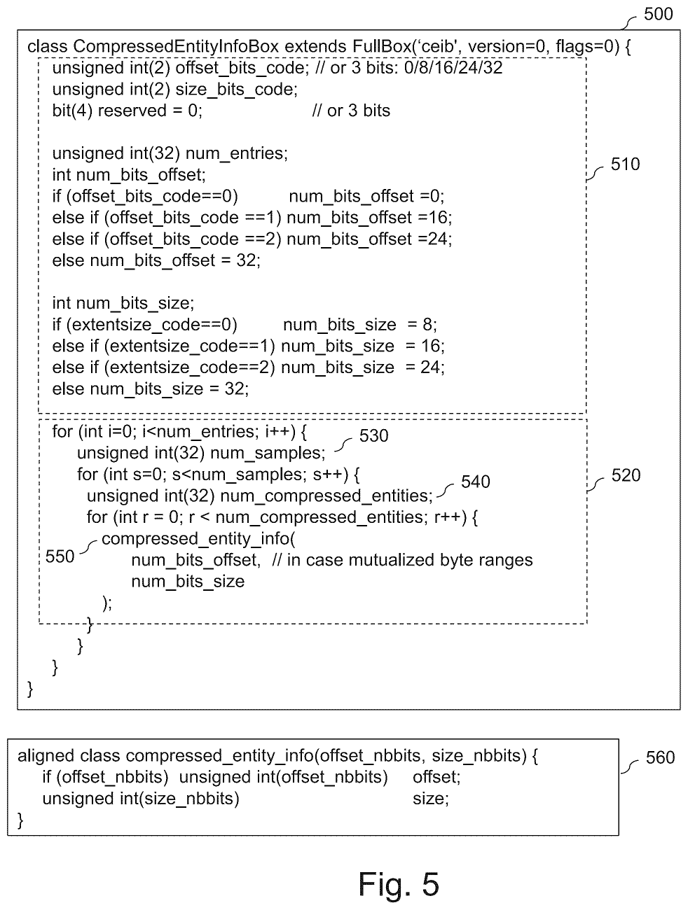

The SubsampleInformationBox defined in ISOBMFF allows associating properties with byte ranges of samples. SubsampleInformationBox describes the subsamples as a list of contiguous byte ranges (meaning that there is no offset and no jump or seek in the data can be described). At the opposite, the indexes on FIG. 4 or 5 allows jump or seek in the data when an offset is encoded respectively in 440 or 550. However, SubsampleInformationBox may be used as an index for compressed entities as illustrated on FIG. 6.

FIG. 6 illustrates an example of using properties associated with byte-ranges of sample for indexing compressed entities of samples.

The assigned properties, for example using the codec_specific_parameters 620 provide the location(s) (or preferably the index(es), the reconstruction, or concatenation order) of a byte range for a given subsample in the reconstructed image. The discardable parameter 610 in SubsampleInformationBox may be used to indicate an entity with useless or non-relevant data (may be skipped at reconstruction or avoided in the selection 325). The data organisation depicted in 650 shows a first mutualized byte range (identical data across entities B1). The properties for the subsamples corresponding to byte ranges Bi (i being between 1 and 6) in 650 are described in 660 and provide indication to reconstruct a sample or an image as illustrated on 670. For example, the compressed entity corresponding to the byte range B1 in the data part of the media file is used in different parts of the reconstructed image 670 (at index 1, 4 and 8). The other subsamples for byte ranges containing relevant data (represented in grey) have as subsample property a single location where it should be appended in the reconstructed image. Where it should be appended actually corresponds to an order in an image buffer for reconstructed sample or image in a parser 120. Using a subsample information box as an index for compressed entity required defining a specific flags value for the box. Reusing the 4CC for uncompressed video makes sense, or the 4CC of the compression configuration box. It is to be noted that the efficient subs representation may also be used to encode the subsample properties as reference to the subsample reference table (not represented).

FIG. 7 illustrates an example of metadata part and box structure to describe uncompressed samples that are generically compressed.

The description of FIG. 7 may change when the generic compressed is combined with usage of encryption. In such a case, the first byte of each compressed entity should be the first byte of a CENC subsample which should have no decryption dependency to previous CENC subsamples. This implies that a full cryptographic block starts on this first byte, and that either CTR (Counter) block chaining is used or that the cypher state is re-initialized at the start of the subsample (i.e. ‘cbcs’ scheme). Accordingly, a media track using both generic compression and common encryption have two sample entry transformations, first for encryption then for generic compression. For a video track, this can be summarized as the following box structure in a SampleTableBox (‘stbl’):
Sample entry type ‘encv’ (for encrypted content)
   ProtectionSchemeInfoBox
      SchemeType ‘cenc’, ‘cbcs’, etc. (one of CENC schemes or modes),
      SchemeInfoBox->TrackEncryptionBox (CENC specific),
      OriginalFormatBox indicating ‘gcmp’ (Generically-compressed media),
   RestrictedSchemeInfoBox (‘rinf’)
      SchemeType ‘gcmp’ (for presence of generic compression),
      SchemeInfoBox->CompressionConfigurationBox, and
      OriginalFormatBox indicating original media format (‘uncv’ for example in case of video)

### Media File Exchanges

When encapsulated media files, for example media file 135 in FIG. 1, have to be exchanged between a server and a client or a media player, their MIME (Multipurpose Internet Mail Extensions) type needs to be indicated. The MIME type may be video or images and the subtype may be mp4 for video and heif for individual images. As there can be a great variety of configurations within this combination of type and subtype, additional indication can be helpful to media players. Having specific item type or sample entry value allows interoperable exchange of media files encapsulating uncompressed image or video data. Indeed, the specific item or sample entry type may be used in the “codecs” parameter of a MIME type to specify the type of the media resource, or in the “itemtypes” parameter of a MIME type for an HEIF file. A client such as client 115 in FIG. 1, may determine by examining the MIME type whether it can render the media tracks or items (or at least some) present in the media file. Likewise, a client with limited resources may, based on MIME types, decide whether it can support and render the media file. Currently, MIME types for ISO Base Media files encapsulating uncompressed data is not specified to enable readers to determine whether the file contains uncompressed or codec-specific video or images and whether the uncompressed video or image has been generic-compressed or whether some decompression algorithm, for example such as the DEFLATE algorithm, should be available at the reader side. Therefore, elements from the above embodiments may be used in some MIME type parameters. This is useful for example, when the file is available on a server for transmission over HTTP, to indicate the content type.

For example, if image data such as image data 125 in FIG. 1 are uncompressed video data, the MIME type may be defined as follows:

MIME type: video/mp4; codecs=SPECIFIC_TYPE; profiles=MAJOR_BRAND
where
SPECIFIC_TYPE corresponds to the specific sample entry type (e.g. ‘ucmp’ or ‘ucpi’ or ‘iraw’ indicating uncompressed video data) and
MAJOR_BRAND corresponds to the value for the major_brand parameter indicated in the ‘ftyp’ box of the media file, for example media file 135 in FIG. 1, or ‘type’ box if the media file comes as segment files. For example, it may be a new brand indicating that some generic compression has to be supported by readers or an extension of the existing ‘isoc’ brand.

In case the encapsulation is done according to FIG. 4, using a specific sample entry for pre-decoding, the MIME type may be the following one:

MIME type: video/mp4; codecs=comp.ucmp; profiles=MAJOR_BRAND
where “comp” indicates a generic compression and “ucmp” uncompressed video samples. Note that ‘comp’ may be replaced by ‘resv’ if the restricted sample entry is used instead of the pre-decoding one indicating a compression.

As another example, if the image data are individual images, encapsulated as image items in the media file, then the MIME type for such file may be as follows:

image/heif; itemtypes=SPECIFIC_TYPE
where
SPECIFIC_TYPE corresponds to the specific item type (e.g. ‘ucmp’ or ‘ucpi’ or ‘iraw’ indicating uncompressed image items). This specific type value may be followed by an indication of a number of pixels for the uncompressed image:
   image/heif; itemtypes=SPECIFIC_TYPE.NB_PIXELS

If the image item corresponding to the uncompressed image is not the primary item of the file (for example if it is another HEVC image such as media data 130 in FIG. 1 that is encapsulated in the same media file), it may be indicated in the itemtypes parameter of the MIME type as one of the comma-separated item declaration as follows:

| | |
|---|---|
| image/heif; | itemtypes= |

hvc1.A1.80.L93.B0+hvcC,SPECIFIC_TYPE.NB_PIXELS

A new parameter may be defined to indicate whether a generic compression has been applied or if data comes as compressed data blocks or compressed entities, possibly indicating the algorithm used for the compression:

| | | | |
|---|---|---|---|
| compression=”deflate” | or | compression=”none” | or |

compression=”bzip2”.

This parameter requires readers to support the given compression algorithm in order to render the media file. When the parameter compression indicates “none” or is not present in the MIME type, then the reader assumes that no a priori decompression is required on encapsulated data, but that there may be byte range mutualization. For a parser to determine more easily whether a byte range mutualization is in use, yet another MIME parameter may be defined, or be combined within the above compression parameter as another authorized value, for example “deflate+mutualization” or instead of “none”, specifying compression=“byte-range-mutualization”.

### Device for Encapsulation or Parsing

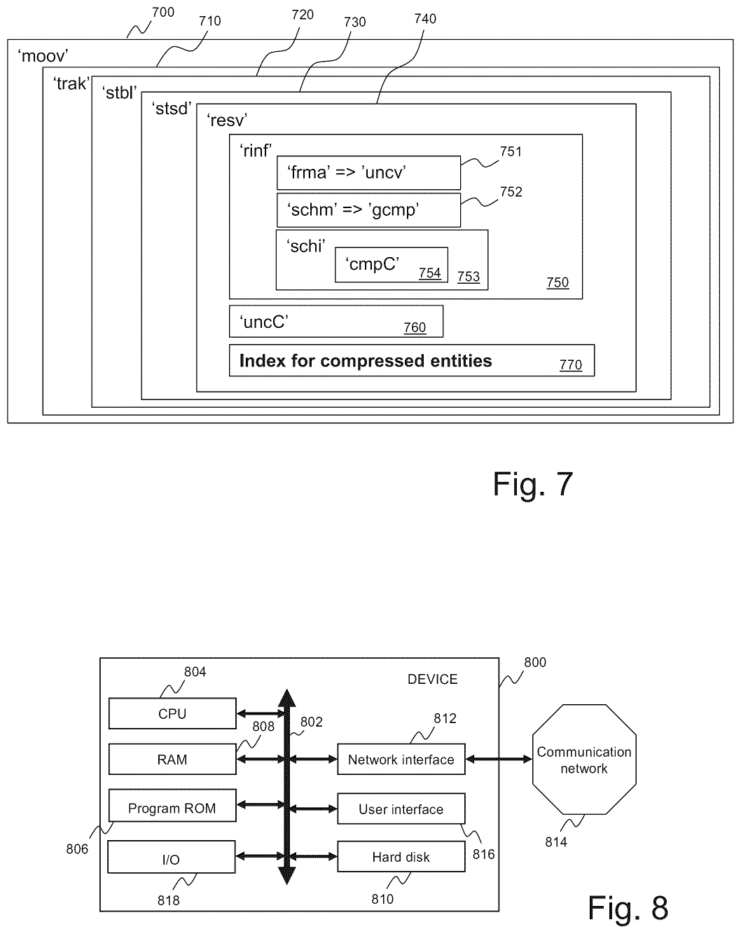

FIG. 8 is a schematic block diagram of a computing device 800 for implementation of one or more embodiments of the disclosure. The computing device 800 may be a device such as a micro-computer, a workstation or a light portable device. The computing device 800 comprises a communication bus 802 connected to:
a central processing unit (CPU) 804, such as a microprocessor;
a random access memory (RAM) 808 for storing the executable code of the method of embodiments of the disclosure as well as the registers adapted to record variables and parameters necessary for implementing the method for transmitting media data, of which the memory capacity can be expanded by an optional RAM connected to an expansion port for example;
a read only memory (ROM) 806 for storing computer programs for implementing embodiments of the disclosure;
a network interface 812 that is, in turn, typically connected to a communication network 814 over which digital data to be processed are transmitted or received. The network interface 812 can be a single network interface, or composed of a set of different network interfaces (for instance wired and wireless interfaces, or different kinds of wired or wireless interfaces). Data are written to the network interface for transmission or are read from the network interface for reception under the control of the software application running in the CPU 804;
a user interface (UI) 816 for receiving inputs from a user or to display information to a user;
a hard disk (HD) 810;
an I/O module 818 for receiving/sending data from/to external devices such as a video source or display.

The executable code may be stored either in read only memory 806, on the hard disk 810 or on a removable digital medium for example such as a disk. According to a variant, the executable code of the programs can be received by means of a communication network, via the network interface 812, in order to be stored in one of the storage means of the communication device 800, such as the hard disk 810, before being executed.

The central processing unit 804 is adapted to control and direct the execution of the instructions or portions of software code of the program or programs according to embodiments of the disclosure, which instructions are stored in one of the aforementioned storage means. After powering on, the CPU 804 is capable of executing instructions from main RAM memory 808 relating to a software application after those instructions have been loaded from the program ROM 806 or the hard-disc (HD) 810 for example. Such a software application, when executed by the CPU 804, causes the steps of the flowcharts shown in the previous figures to be performed.

In this embodiment, the apparatus is a programmable apparatus which uses software to implement the disclosure. However, alternatively, the present disclosure may be implemented in hardware (for example, in the form of an Application Specific Integrated Circuit or ASIC).

While the disclosure has been illustrated and described in detail in the drawings and foregoing description, such illustration and description are to be considered illustrative or exemplary and not restrictive, the disclosure being not restricted to the disclosed embodiment. Other variations on the disclosed embodiment can be understood and performed by those skilled in the art, in carrying out the claimed disclosure, from a study of the drawings, the disclosure and the appended claims.

Such variations may derive, in particular, from combining embodiments as set forth in the summary of the disclosure and/or in the appended claims.

In the claims, the word “comprising” does not exclude other elements or steps, and the indefinite article “a” or “an” does not exclude a plurality. A single processor or other unit may fulfil the functions of several items recited in the claims. The mere fact that different features are recited in mutually different dependent claims does not indicate that a combination of these features cannot be advantageously used. Any reference signs in the claims should not be construed as limiting the scope of the disclosure.

1. A method of encapsulating media data as samples into a media file comprising at least one media data part and at least one metadata part, by a processing device, the method comprising:
generating, based on the media data, at least one sample; and
generating metadata in the at least one metadata part, the generated metadata describing each byte-range of a sequence of byte-ranges of media data of the at least one sample,
wherein metadata describing at least one byte-range of the sequence refer to media data of at least another byte-range previously described in the metadata.

2. The method of claim 1, wherein the at least another byte-range is at least a part of another byte-range of the at least one sample.

3. The method of claim 1, wherein the at least a part of another byte-range is of a run of samples comprising the at least one sample.

4. The method of claim 1, comprising processing at least one entity, the processed at least one entity corresponding to at least one byte-range of the sequence.

5. The method of claim 4, wherein the processing comprises applying a generic compression to the at least one entity and/or encrypting the at least one entity.

6. The method of claim 4, wherein the metadata comprise an indication of the processing applied to the at least one entity.

7. The method of claim 1, wherein the metadata comprise an indication of a size of the at least one sample, the size of the at least one sample being determined as a function of the at least one processed entity.

8. The method of claim 1, wherein the metadata comprise an indication of a size of the at least one sample, the size of the at least one sample being equal to a size of all of the byte-ranges of the at least one sample, that metadata do not refer to media data of another byte-range.

9. The method of claim 1, wherein the metadata describing a byte-range comprises an indication of the size of the byte-range, an offset indicating the first byte of the byte-range being determined as equal to zero or as equal to the sum of all the sizes of previously described byte-ranges of the at least one sample.

10. The method of claim 1, wherein the metadata describing a byte-range comprises an offset from the start of the at least one sample and a size.

11. The method of claim 1, wherein the at least one sample is at least one item corresponding to at least one individual image or at least one sample corresponding to at least one image of a sequence of images.

12. A method of parsing a media file encapsulating media data as samples, by a processing device, the media file comprising at least one media data part and at least one metadata part, the method comprising:
obtaining, from the at least one metadata part, metadata describing each byte-range of a sequence of byte-ranges of at least one sample, metadata describing at least one byte-range of the sequence referring to media data of at least another byte-range previously described in the metadata; and
determining media data corresponding to the at least one sample as a function of the at least other byte-range.

13. The method of claim 12, wherein the at least another byte-range is at least a part of another byte-range of the at least one sample.

14. The method of claim 12, wherein the at least a part of another byte-range is of a run of samples comprising the at least one sample.

15. The method of claim 12, comprising processing at least one byte-range of the sequence, the processed at least one byte-range corresponding to corresponding media data.

16. The method of claim 15, wherein the processing comprises applying an inverse generic compression to the at least one byte-range to be processed and/or decrypting the at least one byte-range to be processed.

17. The method of claim 15, wherein the metadata comprise an indication of the processing to be applied to the at least one byte-range to be processed.

18. The method of claim 12, wherein the metadata comprise an indication of a size of the at least one sample, the size of the at least one sample being equal to a size of all of the byte-ranges of the at least one sample, that metadata do not refer to media data of another byte-range.

19. The method of claim 12, wherein the metadata describing a byte-range comprises an indication of the size of the byte-range, an offset indicating the first byte of the byte-range being equal to zero or to the sum of all the sizes of previously described byte-ranges of the at least one sample.

20. The method of claim 12, wherein the metadata describing a byte-range comprises an offset from the start of the at least one sample and a size.

21. The method of claim 12, wherein the at least one sample is at least one item corresponding to at least one individual image or wherein the at least one sample is at least one sample corresponding to at least one image of a sequence of images.

22. The method of claim 1, wherein the media file is an ISO Base Media File Format (ISOBMFF) standard compliant file.

23. A non-transitory computer-readable storage medium storing instructions of a computer program for implementing the steps of the method according to claim 1.

24. An apparatus for encapsulating media data as samples into a media file comprising at least one media data part and at least one metadata part, the apparatus comprising:
a processor; and
a memory in communication with the processor, the memory storing instructions that, when performed by the processor, cause the processor to:
generate, based on the media data, at least one sample; and
generate metadata in the at least one metadata part, the generated metadata describing each byte-range of a sequence of byte-ranges of media data of the at least one sample,
wherein metadata describing at least one byte-range of the sequence refer to media data of at least another byte-range previously described in the metadata.
